(19) United States
(12) Patent Application Publication
(10) Pub. No.: US 2011/0016682 A1
(43) Pub. Date: Jan. 27, 2011

(54) DRIP IRRIGATION TUBE FITTING TOOL

(76) Inventor: Benjamin H. Wood, III, Poway, CA (US)

Correspondence Address: The Law Office of Jane K. Babin;Professional Corporation, c/o Intellevate, P.O. Box 52050, Minneapolis, MN, 55402, US

(21) Appl. No.: 12/840,460

(22) Filed: Jul. 21, 2010

Related U.S. Application Data
(60) Provisional application No. 61/227,862, filed on Jul. 23, 2009.

(51) Int. Cl. B23P 19/04

(52) U.S. Cl. 29/237

(57) ABSTRACT

The present invention provides a tool for securing fittings for fluid delivery systems, such as drip irrigation systems, and assisting in the assembly of such systems. Specifically, the tool is a device sized and shaped to fit comfortably within the hand of an adult, having a channel therein to accept and secure fittings, which can then be easily be inserted into fluid delivery tubing.

### RELATED APPLICATIONS

This application claims the benefit of priority under 35 USC §119 of U.S. Provisional Application Ser. No. 61/227,862 filed Jul. 23, 2009, the entire disclosure of which is incorporated herein by reference.

### FIELD OF THE INVENTION

The present invention relates generally to the field of hand tools and more particularly to tools for assembling fluid delivery systems, such as drip irrigation systems.

### BACKGROUND OF THE INVENTION

Drip irrigations systems are an increasingly popular method of delivering water to residential, commercial and agricultural plantings. They offer the advantages of delivering water to the root area of the plant where it is most needed, controlling application of water under low pressure, and more efficiently distributing water with less irrigation run-off than other forms of irrigation, such as sprinklers. In many areas where water is in short supply, drip irrigation offers a means for conserving limited water resources.

Drip irrigation systems are typically made from ½ inch flexible plastic supply lines connected to a network of ¼ inch plastic (e.g. polyethylene) distribution tubes. The tubing is connected through a series of typically plastic fittings, including connectors (such as elbows, tees, crosses, and adaptors) and emitters (such as nozzles, sprinklers, bubblers, misters and jets) which discharge irrigation water. The fittings, which may be called compression fittings, usually contain a barb or other adaptation to hold them securely in the tubing. The assembly of the ¼ inch distribution tubes to the fittings is difficult and can consume a significant amount of time and energy during the installation of a drip irrigation system.

When assembled by hand (without the aid of a tool), the small size of the fittings and tubing requires fine motor skills, high grip strength and high pinch strength. Sharp edges on the fittings add discomfort to hands and fingers. Typically wet conditions from residual water in the irrigation systems further exacerbate the challenges by reducing friction, increasing required forces and by softening skin on the fingers and hands, increasing the risk of irritation or injury. Wearing gardening or work gloves is not an effective solution to these problems associated with assembling irrigation tubing due to the high degree of dexterity and fine motor skills required to hold the fittings in place, and to grip and mate the fittings with tubing.

A tool or other device that facilitates installation of fittings into drip irrigation tubing would enable more rapid, and less difficult drip irrigation assembly, lower the risk of injury and would thereby increase the ease of installing these efficient, water-saving systems.

### SUMMARY OF THE INVENTION

The present invention provides a tool for securing tube fittings during assembly of fluid distribution systems. The tool is generally a body adapted to fit into the hand of an adult, having a top, bottom and at least one side, and including at least one fitting channel adapted to receive and secure a tube fitting disposed on the at least one side. The body can be solid or it can be fully or partially hollow. The tool can constructed of any suitable material such as sturdy, rigid or semi-rigid plastic (e.g. a commodity, engineering or high-performance, amorphous or semi-crystalline, thermoplastic or thermoset plastic, including, but not limited to polyvinylchloride (PVC), polycarbonate, epoxy and polystyrene or combinations thereof), which can be manufactured by any suitable method, such as injection molding.

In certain embodiments, the top and bottom of the body are generally round, oval, polygonal or complex curve shaped, and the tool has a single, continuous side. In other embodiments, the tool has four sides and is generally square or rectangular in shape.

Typical dimensions for the tool include an overall size of 1 to 5 inches in length, 1 to 5 inches in width and 0.5 to 3 inches in height, with a fitting channel about 0.25 inches to about 0.40 inches wide.

The fitting channel can include one or more projection ports for receiving projections on a fitting. In certain aspects of the invention, the projection port terminates within the body of the tool, while in other aspects, the projection port traverses the length of the tool and is thus a through-hole. In yet another embodiment, the fitting channel can include at least one notch, groove, ridge, baffle, or taper. In certain aspects of the invention, the fitting channel can include an impression of a fitting.

The present invention also provides tools for securing tube fittings during assembly of fluid distribution systems, that are generally a body adapted to fit into the hand of an adult, having a top, bottom and at least one side; and two or more fitting channels, each fitting channel adapted to receive and secure a tube fitting. For example, the fitting channels can each be adapted to accept fittings of different sizes, such as ¼ inch fittings and ½ inch fittings.

### BRIEF DESCRIPTION OF THE DRAWINGS

FIG. 1 shows front perspective view of a tool according to one embodiment of the invention.

FIG. 2 shows a front plan view of a tool according to one embodiment of the invention.

FIG. 3 shows a side perspective view of a tool according to one embodiment of the invention.

FIG. 4 shows a side plan view of a tool according to one embodiment of the invention.

FIG. 5 is a cross sectional view of a tool according to one embodiment of the invention having a blind hole projection port with a tube fitting seated therein. The fitting is restricted in the blind hole projection port is restricted due to the about 45° angle at terminus 17 of the projection port.

FIG. 6 is a cross sectional view of a tool according to one embodiment of the invention having a through hole projection port. The tool is shown with a tube fitting seated in the projection port with a length of tubing extending through the through hole.

FIGS. 7A-7C are perspective drawings showing a tool of the invention with three similar fittings seated in the fitting channel. FIG. 7A shows the tool with a “T” type fitting. FIG. 7B shows the tool with an “L” type fitting. FIG. 7C shows the tool with a straight connector type fitting. The groove 50 allows fittings with a particular geometry to be seated securely in the fitting channel 13. Because each of the fittings shown has a similar geometry that is accepted by the grooved channel, the tool shown universally accepts all three fittings.

FIGS. 8A-8B illustrate an embodiment of the tool of the invention with an alternate, ergonomic complex curve shape. FIG. 8A is a top plan view of the tool of the invention with an alternate, ergonomic complex curve shape. FIG. 8B is a bottom perspective view of the tool shown in FIG. 8A. FIG. 8C is a top perspective view of the tool shown in FIG. 8A. FIG. 8D is a side perspective view of the tool shown in FIG. 8A.

### DETAILED DESCRIPTION

Unless otherwise noted, the terms used herein are to be understood according to conventional usage by those of ordinary skill in the relevant art. It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The present invention provides hand tools for use in the assembly of tubing used in irrigation water distribution systems (i.e. drip irrigation) and other fluid supply assemblies. The tools, which are designed to be held in one hand, are adapted to securely hold tube fittings in place while tubing it attached to a connection on the fitting with the other hand. The tools can be modified for use with any size tubing and tube fittings. In certain embodiments, the tool is adapted for use with standard ¼ inch tubing.

The tool provides ergonomic improvement over manual insertion of fittings, thereby enabling users with limited hand strength to complete the task of drip irrigation assembly. In addition, using the tools of the invention, all users can assemble connections more rapidly and complete more connections in a single work session without fatigue or injury.

The tool of the present invention replaces the high grip strength required to connect tubes and tube fittings by providing an ergonomically shaped receptacle for holding a fitting with one whole hand, while connecting tubing to the fitting with the other hand. The tool eliminates contact between the sharp edges of fittings with the user's fingers during the application of high forces and torque required to insert and secure fittings within drip irrigation or other tubing, thereby increasing comfort and avoiding injury to the operator.

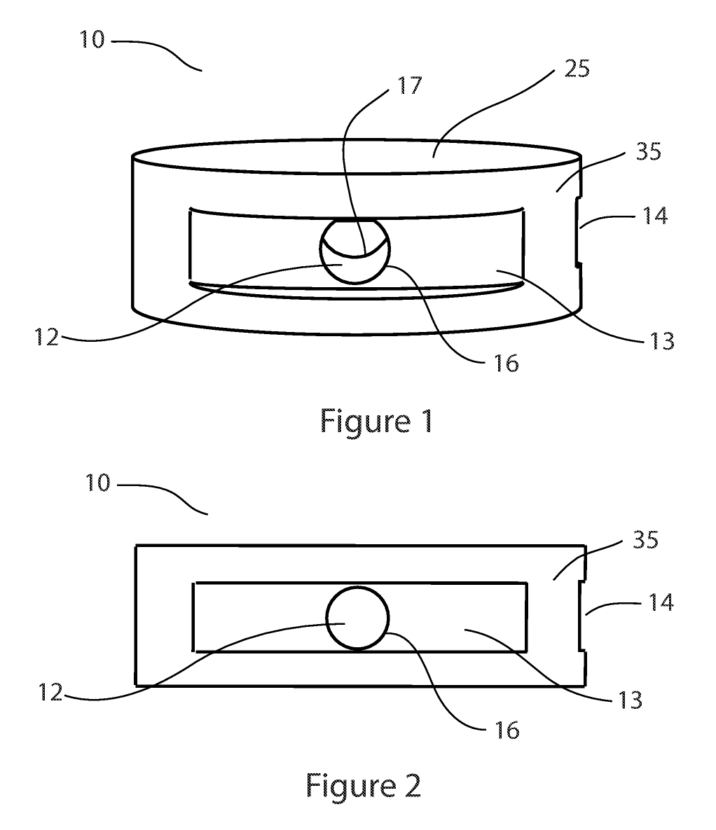

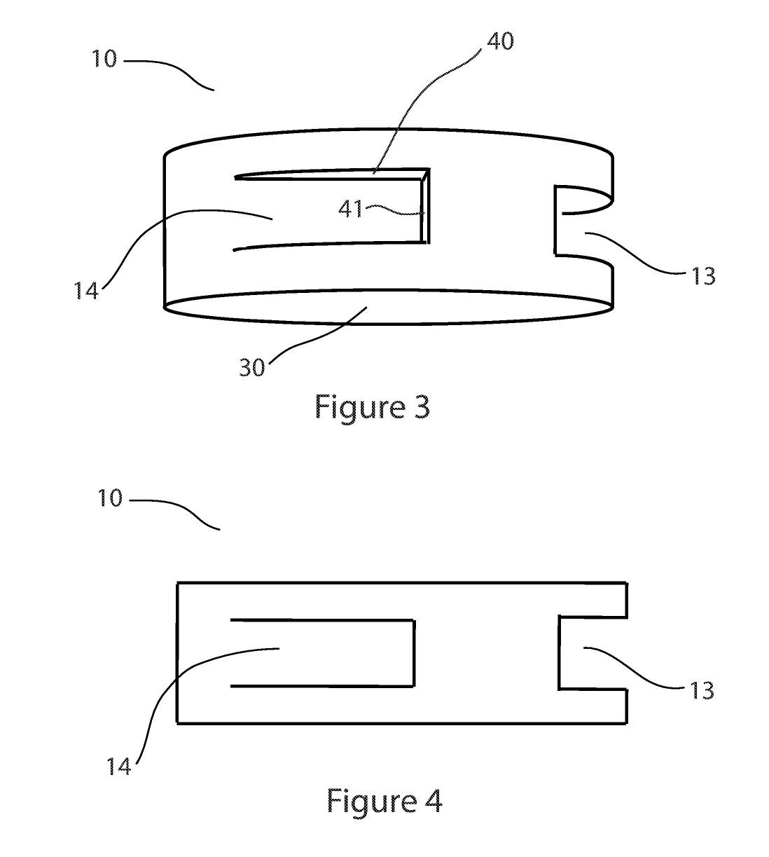

Referring to FIGS. 1 and 2, the tool is generally a solid body 10 shaped and sized to fit comfortably within the hand of an adult, having a top 25, a bottom 30 (shown in FIG. 3), at least one side 35 and having disposed thereon at least one fitting channel 13 adapted for securely, yet removably accepting a tube fitting, such as a drip irrigation union, elbow (“L), tee (“T”), cross, connector, adaptor or emitter. Such tube fittings are well known in the art and may be purchased from retail and wholesale suppliers such as Toro, Orbit, Rainbird and DIG.

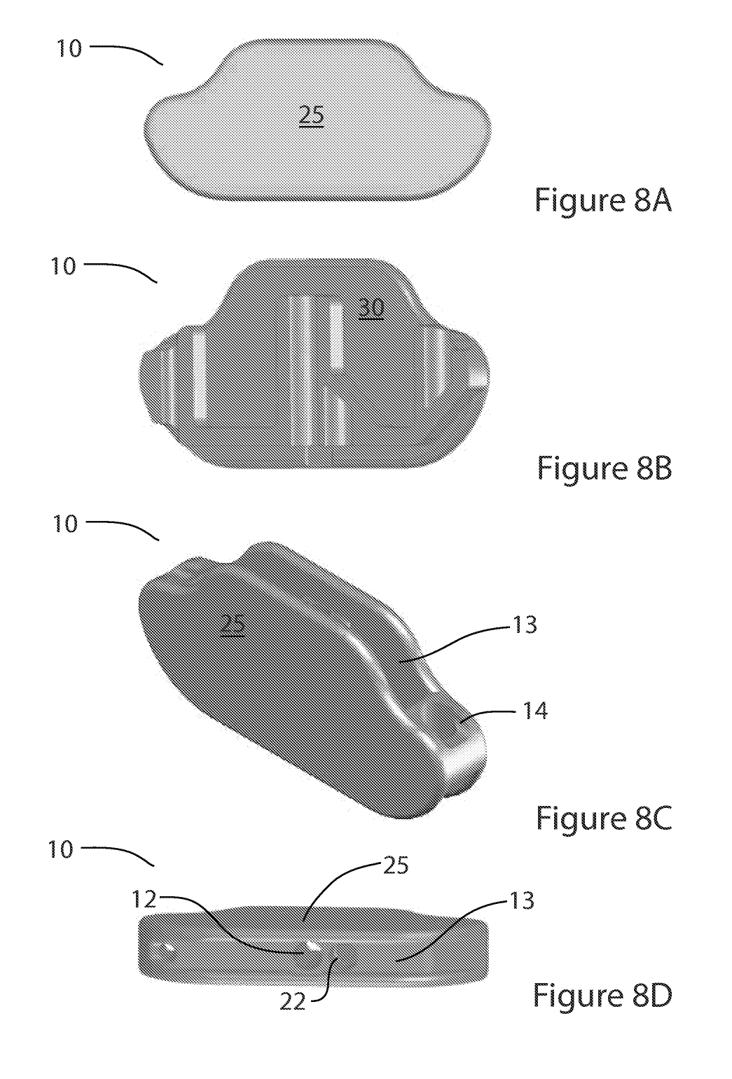

The tool can be any shape, such as round, oblong, polygonal, pentagonal, columnar, complex curved or a combination shape. In certain non-limiting embodiments, where sharp angles are inherent in the design (e.g. cube, star, rectangular, pyramidal, or triangular shapes), the tool will preferably have rounded edges and corners that will not stab, pinch or cut into the operator's hand. In some aspects of the invention as shown in FIGS. 8A-8D, the tool may have a free-form shape designed to accommodate the contours of a human hand, without distinct edges or corners, as shown in FIGS. 8A-8D.

The at least one side 35 may be continuous (e.g. when the top and bottom are generally round), or the tool may include multiple sides, such as distinct back, front, right and left sides (e.g when the top and bottom are generally rectangular). In other embodiments, the tool has a number of sides dictated by the shape of the top 25 and bottom 30. For example, when the top and bottom of the tool are pentagonal, the tool will have five sides.

The tool can be any size, and will typically be suitable for holding with one hand. Generally, the tool has an overall size of about 1 to about 5 inches wide by about 1 to about 5 inches long and has a thickness of about 0.5 to about 3 inches; frequently, the tool is about 1.5 to about 3 inches wide, by about 3 to about 5 inches long and has a thickness of about 0.5 to about 1.5 inches; and often the tool is about 2 inches wide by about 4 inches long and has a thickness of about 0.6 inches. Although embodiments of the tool illustrated in the non-limiting drawings have an overall flattened shape which is wider and longer than it is thick, tools having tops, bottoms and sides of substantially equal size and/or shape are also contemplated, as are tools in which the top and/or bottom is not a flat plane, such as a sphere, egg shape or the like.

“About” as used herein means that a number referred to as “about” comprises the recited number plus or minus 1-10% of that recited number. For example, about 50 inches can mean 45-55 inches or as few as 49-51 inches depending on the situation. Whenever it appears herein, a numerical range, such as “45-55”, refers to each integer in the given range; e.g., “45-55 inches” means that the percentage can be 45 inches, 46 inches, etc., up to and including 55 inches. Where a range described herein includes decimal values, such as “1.2 inches to 10.5 inches”, the range refers to each decimal value of the smallest increment indicated in the given range; e.g. “1.2 inches to 10.5 inches” means that the percentage can be 1.2 inches, 1.3 inches, 1.4 inches, 1.5 inches, etc. up to and including 10.5 inches; while “1.20 inches to 10.50 inches” means that the percentage can be 1.20 inches, 1.21 inches, 1.22 inches, 1.23 inches, etc. up to and including 10.50 inches.

The at least one channel 13 is a generally rectangular slot or groove in a side of the tool, which is adapted for accepting one or more types of tube fittings, and may be further adapted for restraining the fittings. In certain embodiments, the channel traverses the full length of the side 35 on which it is disposed. Thus, the channel is of sufficient size to accommodate and securely hold at least one type of fitting and facilitate connection of the fitting to a tube. FIG. 1 shows fitting channel 13 disposed on a tool according to the invention having a generally round top and bottom, and a continuous side. In other embodiments, fitting channel 13 is disposed e.g. on the front side of the tool.

The fitting channel 13 will generally have a width sufficient to securely receive a tube fitting. The fitting channel can be adapted by shape and/or notches therewithin to provide resistance to rotational forces placed upon the fitting during connection to tubing by securing the fitting in the channel.

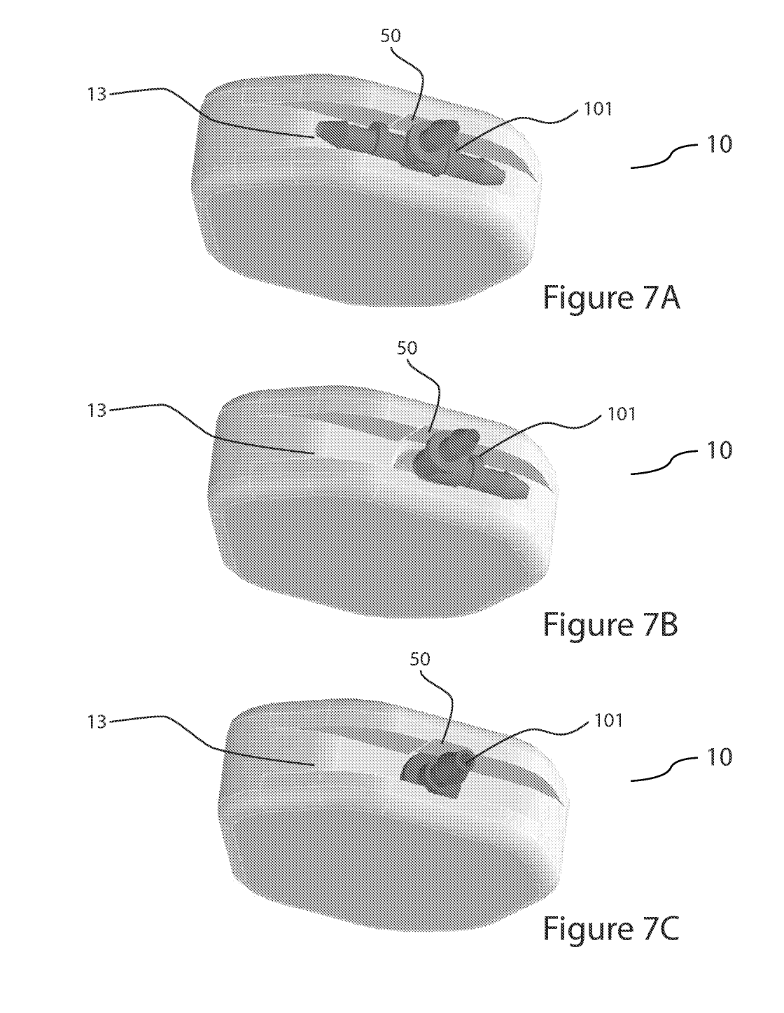

In one embodiment, the channel 13 has a “universal” shape and size that can accept a variety of different fittings. By “universal” it is meant that the channel accepts at least two and preferably a plurality of fitting types or geometries, although not all fittings may be accommodated by a universal channel. For example, a universal channel may be adapted with a particular shape and size suitable for accepting all, most or a multiplicity of fittings made by a particular manufacturer, as illustrated in FIGS. 7A-7C.

In operation, a fitting is placed in the channel such that the end of a fitting terminus or connector designed to be inserted into a tube is exposed. In this manner, the fitting can be held in the tool indirectly by the operator while the exposed fitting end is inserting into the end of a length of tubing. Such a fitting channel 13 according to this embodiment of the invention will generally have a width at least about the same or slightly larger than the width of the largest fitting it is designed to accept. In certain embodiments, the fitting channel 13 is about 0.25 inches to about 0.40 inches wide. Even wider channels are contemplated where larger tube fittings are used, such as fittings for ½ inch tubing.

The fitting channel 13 is of sufficient depth that the fitting can be seated within the fitting channel with a tubing connection exposed and accessible for inserting into the end of a tube. The fitting channel is typically at least about 0.1 to about 0.5 inches in depth, frequently at least about 0.15 inches to about 0.4 inches in depth, and often at least about 0.2 to about 0.3 inches deep.

The fitting channel may have a uniform width, or it may taper continuously from a first end to second end. When a continuous taper is present, the first end of the channel has a width sufficient to accept the largest dimension of fittings used with the tool. When inserted into the tool at the first end of fitting channel 13, the fitting can be slid toward the second, narrower end until resistance is felt. The fitting can thus be held securely in place by frictional force in the fitting channel while a length of tubing is attached thereto. In other embodiments, the fitting channel 13 may have a local taper located anywhere along the length of the channel, may have a stepped width, or may include a combination of these configurations to securing fittings within the fitting channel 13. Such tapers and steps are useful where fittings of a variety of sizes and shapes are used with the tool, or the fittings are non-uniform in diameter. In other embodiments of the invention, the fitting channel may have ridges, grooves, baffles, protrusions, chamfers, curves and the like disposed thereon to create resistance to movement of a fitting inserted therein.

The tool may also include one or more partial channels 14, each forming a notch-shaped depression in a side of the tool, the notch having two triangular or wedge shaped side walls 40 and a rectangular end wall 41, as illustrated in FIGS. 3 and 4. In use, the end wall of a partial channel 14 provides a stop to the movement of a fitting within the channel. Partial channels 14 in the tool may include all the features of full-length channels 13, such as tapers, steps, ridges, groves and other configurations described herein.

In certain embodiments, channel 13 or partial channel 14 may include notches, grooves, depressions and the like along one or more inner surface(s) thereof, to accept fittings of a particular geometry. FIGS. 7A-7C illustrate a channel 13 with a notch 50 adapted for accepting three different fittings with similar geometry.

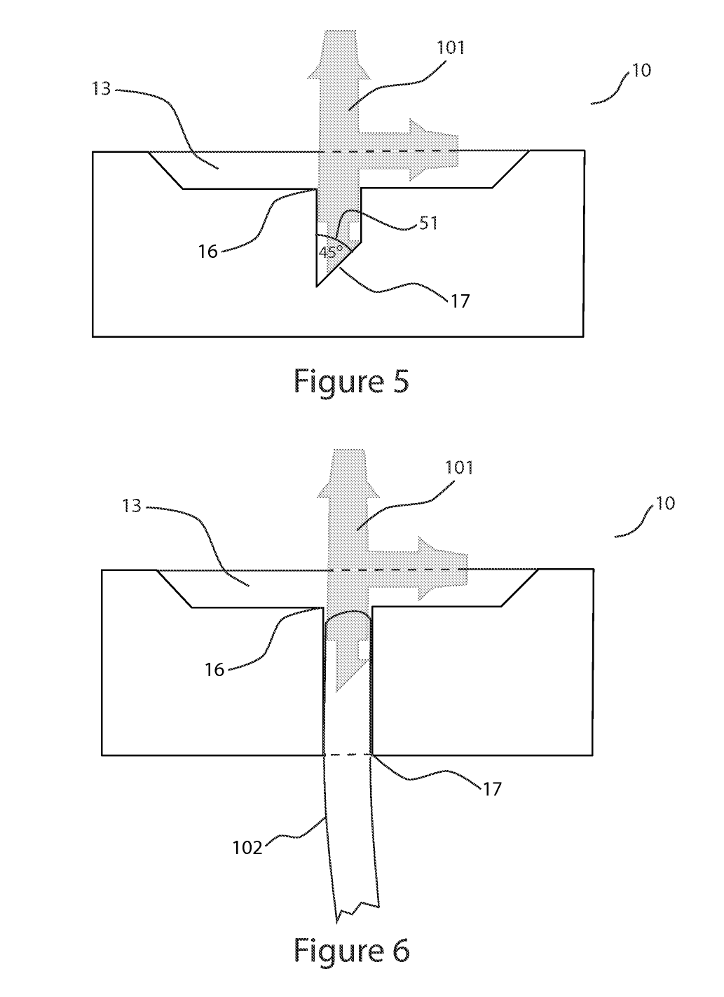

The skilled artisan will appreciate that fittings may include projections, such as valves, knobs and multiple connection ports, which can be accommodated by the tool. To accept fittings with projections, for example, the channel may include a hollow, generally cylindrical port 12 for accepting the projection, the port having a first (proximal) end 16 disposed on a surface of the channel 13, and a second end 17 distal to the first end. The port 12 may be a blind hole 22, terminating within the body of the tool (as shown in FIG. 5) or it may be a through hole 23 (as shown in FIG. 6), traversing the length of the tool and opening e.g. onto a side of the tool opposite the channel 13.

When the port is a blind hole, the distal end of the port 12 can be shaped or angled to accept a specific orientation of a fitting placed therein. For example, the second end 17 of a blind hole can terminate at a fixed angle of about 45 degrees 51 relative to the first end 16, as illustrated in FIG. 5, thereby accepting projections on certain fittings 101 that terminate in a mated 45° angle. When the port has an angled-stop end 51, the port can accommodate only one rotational orientation of the fitting when the mated projection is fully seated in the port. Accordingly, the mated fitting can be securely restrained in the tool. It is well known in the art that connectors on fittings from many manufacturers terminate at an angle, generally about 45 degrees. Thus, this aspect of the invention will have wide applicability to a variety of fittings. Resistance can be provided for non-angled fittings through a port that tapers from its proximal to distal end, allowing a fitting to be retained by frictional forces.

When the port is a through hole, the port allows the tool to accept a fitting 101 having a length of tubing 102 connected to one end, while exposing an unconnected tubing connector of the fitting, as shown in FIG. 6. The exposed end of the fitting can then be connected to another length of tubing without disturbing the first tubing connection. This embodiment of the invention will also assist the operator in managing connections on unwieldy lengths of tubing where the tubing is long or tends to kink.

In yet further embodiments, the at least one channel 13 comprises an impression or mold of an individual fitting. Such tools, according to the invention, may be used to repeatedly connect tubing to a specific fitting, such as one type of connector from a particular manufacturer. The skilled artisan will appreciate that a similar effect can be achieved by strategic placement of baffles, ridges or the like along the length of the fitting channel.

In certain aspects, the tool may contain multiple fitting channels, each disposed on a discrete side or area of the tool and mated to a specific type of fitting. For example, an octagonally-shaped tool according to the invention may include eight fitting channels (one channel per side), each mated to and accepting of a different type of fitting.

The tools of the invention can be made of any material having sufficient strength to accept tube fittings and retain them in place during insertion into a tube. Nonlimiting examples of materials suitable for construction of the tool of the invention include wood, metal, metal alloys, plastic and the like. In certain embodiments, the tool is made from plastic, such as a PVC, polycarbonate, epoxy, polystyrene and/or other composites and resins well known in the art. Any plastic material can be used that has appropriate flow characteristics for the manufacturing process, and sufficient strength and toughness to withstand repeated tube-fitting assembly. The tool can be manufactured by any suitable process, such as by molding, casting, carving, machining fabricating and the like. In one embodiment, the tool is made by injection molding of plastic. In certain embodiments of the invention, the tool is formed as a single piece of plastic. In other embodiments, two or more pieces of plastic are manufactured and the parts assembled to form the tool.

In certain embodiments of the invention, the top, bottom and/or sides of the tool are contoured and/or include patterns, textures or impressions made during fabrication. Such contours and textures can provide a non-slip surface suitable for use in wet conditions outdoors and/or with tubing that has recently been in use for irrigation. In some embodiments, certain contours of the tool are machined after molding or applied to the molded tool body, such as by spraying or coating. Preferably, the tool has an ergonomic shape that includes chamfers and/or rounded edges that will not dig into the hand of an operator. The body of the tool may be adapted for acceptance by the right had of the operator, the left hand of operator, or may be ambidextrous.

In certain embodiments of the invention, a fitting channel 13, partial fitting channel 14, or projection port 12 may also include a textured surface that provides additional resistance to movement of a fitting placed in the tool. The textured surface may be formed during a molding process used to manufacture the tool, or it may be applied to the surface after molding is completed, such as by machining, etching, or drilling the inner surface of a fitting channel 13, partial fitting channel 14, or projection port 12. In other aspects of the invention, a fitting channel 13, partial fitting channel 14, or projection port 12 may be lined or coated with a resilient or slip-resistant material, such as silicone rubber or plastic to prevent slippage and rotation of the tube fitting. When present, the lining or coating on the fitting port may be applied by any available method, such as by spraying or painting. Alternatively, a pre-formed sleeve of suitable material may be inserted into and/or adhered to the inner surface of a fitting channel 13, partial fitting channel 14, or projection port 12.

Optionally, the tool may contain clips or other attachments for securing the fitting or tubing during operation; a punch for creating holes in ½ inch plastic supply pipe; a bottle opener; a can tab opener; tubing cutter; a tool for extracting damaged or worn fitting, and the like. In certain embodiments, the tool includes one or more holes for stringing, hanging, or displaying the tool

In operation, the tool is held in one hand of the operator and a tube fitting is secured in the fitting channel 13 or partial fitting channel 14 such that the end of the fitting adapted for insertion into a tube (e.g. the barbed end) is exposed on the surface of the tool. Insertion of the fitting into the fitting channel will typically require only normal hand force and/or torque. Lubricant, such as oil or water may be applied to the fitting to facilitate insertion into the fitting channel 13 or partial fitting channel 14. A length of tubing is then grasped with the operator's opposite hand the tube fitting inserted therein.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A tool for securing tube fittings during assembly of fluid distribution systems, comprising
a) a body adapted to fit into the hand of an adult, having a top, bottom and at least one side; and
b) at least one fitting channel disposed on the at least one side, wherein the fitting channel is adapted to receive and secure a tube fitting.

2. The tool of claim 1, wherein the body is generally solid.

3. The tool of claim 1, wherein the body is constructed of plastic.

4. The tool of claim 3, wherein the plastic is selected from polyvinylchloride, polycarbonate, and polystyrene.

5. The tool of claim 1, wherein the tool is constructed by injection molding.

6. The tool of claim 1, wherein the top and bottom have a generally round, oval, polygonal or complex curve shape.

7. The tool of claim 6, wherein the at least one side is a continuous side.

8. The tool of claim 1, wherein the tool has four sides and the top and bottom have a generally square or rectangular shape.

9. The tool of claim 1, having an overall size of 1 to 5 inches in length, 1 to 5 inches in width and 0.5 to 3 inches in height.

10. The tool of claim 1, wherein the fitting channel comprises at least one projection port.

11. The tool of claim 9, wherein the projection port terminates within the body of the tool.

12. The tool of claim 9, wherein the projection port traverses the length of the tool.

13. The tool of claim 1, wherein the diameter of the fitting channel is about 0.25 inches to about 0.50 inches.

14. The tool of claim 1, wherein the fitting channel comprises a notch, groove, ridge or baffle.

15. The tool of claim 1, wherein the fitting channel is tapered.

16. The tool of claim 1, wherein the fitting channel comprises an impression of a fitting.

17. A tool for securing tube fittings during assembly of fluid distribution systems, comprising
a) a body adapted to fit into the hand of an adult, having a top, bottom and at least one side; and
b) at least two fitting channels, wherein each fitting channel is adapted to receive and secure a tube fitting.

18. The tool of claim 17, wherein the at least two fitting channels accept fittings of different sizes.

19. The tool of claim 18, where at least one of the fitting channels accepts ¼ inch fittings.
